(19) United States
(12) Patent Application Publication
(10) Pub. No.: US 2003/0079564 A1
(43) Pub. Date: May 1, 2003

(54) Variable length automotive gear shifter

(76) Inventor: Pete P. Thiengtham, Berkely, MI (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/055,486

(22) Filed: Oct. 29, 2001

(51) Int. Cl. G05G 1/04

(52) U.S. Cl. 74/525

(57) ABSTRACT

A variable length gear shifter for an automobile transmission includes at least two hollow elongated telescoping members movable relative to one another along a longitudinal axis and a releasable lock for locking the telescoping members telescoped together in a selected one of a plurality of predetermined locking positions. One of the telescoping members has an end that is adapted to be attached to a shaft extending from a transmission and another of the telescoping members extends to a free end for grasping by a human hand. Each locking position determines a different distance between the end of the one telescoping member and the free end of the other telescoping member.

### BACKGROUND OF THE INVENTION

The present invention relates generally to automotive gear shifters and, in particular, to a variable length automotive gear shifter.

A growing trend in the automotive industry has been to provide more features in the automobile interior to ensure the comfort of the automobile's driver. By ensuring the driver's comfort, the driver is more alert and the easier it is for him or her to concentrate on operating the vehicle safely, which increases the safety and security of the passengers and the drivers of other automobiles on the road. Examples of these automotive interior driver comfort features have included adjustable driver's seats, adjustable interior and exterior mirrors, adjustable steering wheels, and adjustable brake and accelerator pedals. As larger vehicles have become available to the public, these comfort features have proved especially helpful for more petite drivers.

After all these adjustments have been made, however, the gear shifter may be in an inaccessible or inconvenient position for the driver. This is especially true for automobiles having manual transmissions, as the gear shifter must be utilized much more frequently than in automobiles with automatic transmissions. Often a driver will adjust the seat and steering wheel in order to operate the shifter, rather than place the seat and steering wheel in a more comfortable position to steer and operate the brake and accelerator pedals.

The art has recognized that the gear shifters provided by the automobile manufacturers are not ideal for all situations and has provided gear shifters for making smoother, quicker shifts, particularly in automobile racing by reducing the distance the gear shifter is required to move in order to change gears. These prior art shifters, however, simply replace a stock gear shifter with a shifter that is shorter in length and that is easier and quicker to manipulate during vehicle operation. The art has not provided a gear shifter that is adjustable to different lengths for increased driver comfort.

Especially in automobiles equipped with manual transmissions, it is desirable to place the shifter in as advantageous a position as possible because the shifter must be utilized more often than a corresponding shifter for an automatic transmission. Those skilled in the art will also appreciate that automobiles are driven often by drivers of different heights and the ability to adjust the length of the shifter to accommodate these different drivers is highly desirable. It is desirable to increase the comfort of an automobile driver by providing an adjustable gear shifter.

It is an object of the invention, therefore, to provide a variable length automotive gear shifter that may be attached to the shaft extending from the automotive transmission to replace the non-adjustable gear shifter provided by the automobile manufacturer or by an aftermarket company. It is another object of the present invention to provide an aesthetically pleasing variable length automotive gear shifter that may also be advantageously locked in place after being adjusted.

### SUMMARY OF THE INVENTION

The present invention concerns a variable length automotive gear shifter for use in a vehicle interior. The gear shifter includes three preferably tubular slidingly engageable telescoping members having upper and lower ends. The upper end of a base telescoping member receives the lower end of an intermediate telescoping member. The upper end of the intermediate member receives the lower end of an upper telescoping member. The telescoping members can telescope from a fully extended position to a fully retracted position, advantageously enabling the gear shifter to vary its effective length. The telescoping members are biased in the fully extended position by compression springs. Each telescoping member has a plurality of vertically aligned grooves and a plurality of vertically aligned locking notches formed in an interior surface thereof. The grooves and locking notches are radially spaced apart from each other. The base member has the largest outside diameter and is preferably affixed at the lower end to a shaft extending upwardly from a gearbox of an automobile transmission through the floor of the vehicle. The base member does not move with respect to the other telescoping members. The upper end of the upper member receives a preferably tubular sleeve having a handle attached to an upper portion of an exterior surface thereof. The handle may be spherical, rectangular, tubular or any suitable shape. The handle has an axial bore formed therein for receiving a key lock.

Disposed within the respective inner diameters of the sleeve, the upper telescoping member, and the intermediate telescoping member are generally “T”-shaped shaft guides having an elongated cylindrical member extending from a disk-shaped base member. Each outer end of the base members includes bores formed therein that receive spring-biased locking balls for cooperating with the grooves and locking notches of the telescoping members. The base member of the upper shaft guide receives the cylindrical member of the intermediate shaft guide. The base member of the sleeve shaft guide receives the cylindrical member of the upper shaft guide.

The key lock receives a key, preferably the vehicle ignition key, which enables the key lock to rotate when the key is inserted therein. A shaft extending downwardly from the key lock attaches to the cylindrical member of the sleeve shaft guide, enabling the key lock to rotate the sleeve shaft guide, the upper shaft guide, and the intermediate shaft guide with respect to the telescoping members. In the locked position, the locking balls are disposed in the locking notches of the telescoping members. When the key is inserted into the key lock and rotated to an open, unlocked position, the locking balls align with the grooves of the telescoping members, enabling movement of the telescoping members by applying an upward or downward force to the telescoping members. An antirotation means prevents the telescoping members from rotating relative to one another when the gear shifter is rotated to the open, unlocked position. After the gear shifter is at its desired length, the key lock is rotated to the closed, locked position so that the shifter may be used in a normal, safe manner. The effective length of the gear shifter is thus advantageously adjustable from a fully extended position to a fully retracted position including numerous intermediate positions that correspond to the locking notches on the interior surfaces of the telescoping members.

The present invention advantageously provides another means for ensuring driver comfort, increasing the safety of the vehicles on the road while also providing an aesthetically pleasing means for adjusting the effective length of the gear shifter. In addition, the gear shifter can include an aesthetically pleasing outer covering or boot disposed below the handle. The covering or boot covers and protects the moving parts of the gear shifter from damage such as damage from foreign objects introduced inadvertently between the inside and outside diameters of the telescoping members.

The present invention is not limited to gear shifters for manual transmissions and contemplates use with automatic transmission shifters installed either on the floor of the automobile or on the steering column. The material with which the components of the shifter are to be constructed is not critical, except for the fact that they must be able to withstand the forces normally encountered during shifting. The telescoping members and guide shafts are preferably tubular but can be rectangular or triangular in cross-section or any type of cross-section or profile while remaining within the scope of the present invention. The number of telescoping members could also be only two or four or more while still remaining within the scope of the invention.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a cross-sectional view of a fully extended variable length gear shifter in accordance with the present invention;

FIG. 2 is a top plan view of a gear shift handle attached to the gear shifter of FIG. 1 and showing unlocking and locking directions;

FIGS. 3a and 3b are cross-sectional views as if taken along a line 3-3 of a complete gear shifter of FIG. 1 and showing the gear shifter in an unlocked position and a locked position respectively;

FIGS. 4a and 4b are cross-sectional views as if taken along a line 4-4 of a complete gear shifter of FIG. 1 and showing the gear shifter in an unlocked position and a locked position respectively; and

FIG. 5 is a cross-sectional view of the variable length gear shifter of FIG. 1 in a fully retracted position.

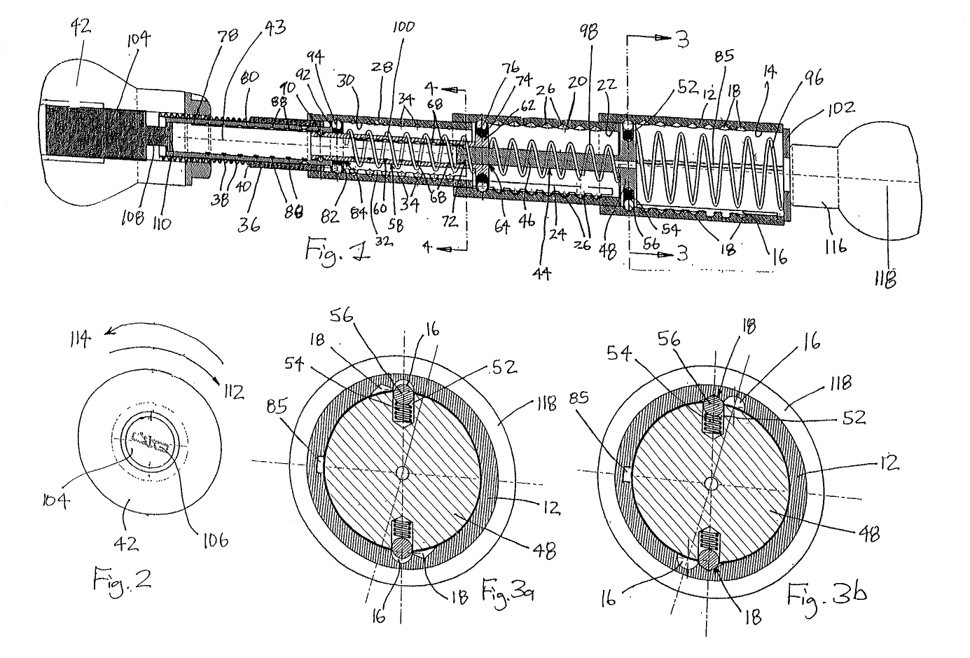

### DESCRIPTION OF THE PREFERRED EMBODIMENT

Referring now to all of the drawing figures, a variable length automotive gear shifter is shown generally at 10. The gear shifter 10 includes a generally tubular base telescoping member 12 having upper and lower ends. An interior surface 14 of the base member 12 includes a plurality of vertically aligned and axially spaced apart grooves 16 and a plurality of vertically aligned and axially spaced apart locking notches 18 formed thereon. The grooves 16 are radially spaced apart from the locking notches 18.

An upper end of the base telescoping member 12 receives a lower end of a generally tubular intermediate telescoping member 20. An interior surface 22 of the intermediate member 20 includes a plurality of vertically aligned and axially spaced apart grooves 24 and a plurality of vertically aligned and axially spaced apart locking notches 26 formed thereon. The grooves 24 are radially spaced apart from the locking notches 26.

An upper end of the intermediate member 20 receives a lower end of a generally tubular upper telescoping member 28. An interior surface 30 of the upper member 28 includes a plurality of vertically aligned and axially spaced apart grooves 32 and a plurality of vertically aligned and axially spaced apart locking notches 34 formed thereon. The grooves 32 are radially spaced apart from the locking notches 34. The telescoping members 12, 20, and 28 can telescope from a fully extended position, best seen in FIG. 1, to a fully retracted position, best seen in FIG. 5. An upper end of the upper member 28 receives a lower end of a generally tubular sleeve 36. The lower end of the sleeve 36 has a first diameter and includes a stepped portion 40 that extends to an upper end having a second diameter. The second diameter of the upper end of the sleeve 36 is less than the first diameter of the lower end of the sleeve 36. The upper end of the sleeve 36 includes a plurality of threads 38 formed on an exterior surface thereof for threadably engaging a gear shifter handle 42.

A lower end of the base telescoping member 12 is affixed to a shaft 116 by a weld washer 102. The shaft 116 preferably extends upwardly from a shift knuckle 118, which is preferably further attached to a shaft 120 extending upwardly from an automotive transmission 122. Alternatively, the base member 12 is attached to the shaft 116 by threads or similar attachment means. The base member 12, therefore, remains stationary and does not telescope with respect to the intermediate member 20 and the upper member 28.

A generally T-shaped intermediate shaft guide 44 having an elongated cylindrical member 46 extending from a generally disk-shaped pedestal member 48 is received by the base telescoping member 12 and the intermediate telescoping member 20. An outer surface of the pedestal member 48 includes a plurality of generally cylindrical bores 52 formed therein. Each bore 52 receives a preferably helical locking spring 54 for biasing a spherical locking ball 56. The locking balls 56 cooperate with the grooves 16 and locking notches 18 of the base telescoping member 12.

A generally T-shaped lower shaft guide 58 having an elongated tubular member 60 extending from a generally disk-shaped base member 62 is received by the intermediate telescoping member 20 and the upper telescoping member 28. The base member 62 includes an axial bore 64 formed therein for receiving an upper portion of the cylindrical member 46 of the intermediate shaft guide 44. An inner surface of the tubular member 60 includes a plurality of vertically aligned and axially spaced apart grooves 66 and a plurality of vertically aligned and axially spaced apart locking notches 68 formed therefrom. The grooves 66 are radially adjacent the locking notches 68. The cylindrical member 46 of the intermediate shaft guide 44 extends to an inner surface of the tubular member 60 of the lower shaft guide 58. An outer surface of the cylindrical member 46 preferably includes a plurality of notches 70 formed therefrom for each receiving a locking ball 72 for cooperating with the grooves 66 and the locking notches 68 of the tubular member 60. An outer surface of the base member 62 includes a plurality of generally cylindrical bores (not shown) formed therein. Each bore receives a preferably helical locking spring 74 for biasing a spherical locking ball 76. The locking balls 76 cooperate with the grooves 24 and locking notches 26 of the intermediate telescoping member 20.

A generally T-shaped sleeve shaft guide 78 having an elongated tubular member 80 extending from a generally disk-shaped pedestal member 82 is received by the intermediate member 20 and the upper member 28. The pedestal member 82 includes an axial bore 84 formed therefrom for receiving an upper portion of the tubular member 60 of the upper shaft guide 58. An inner surface of the tubular member 80 includes a plurality of vertically aligned and axially spaced apart grooves (not shown) and a plurality of vertically aligned and axially spaced apart locking notches 88 formed thereon. The grooves are radially adjacent the locking notches 88. Alternatively, a plurality of grooves (not shown) extends axially along the entire length of the interior surface of the tubular member 80. The tubular member 60 of the upper shaft guide 58 extends to the inner surface of the tubular member 80 of the sleeve shaft guide 78. An outer surface of the tubular member 60 preferably includes a plurality of notches formed therefrom for each receiving a locking ball 90 for cooperating with the grooves and the locking notches 88 of the tubular member 88. An outer surface of the pedestal member 82 includes a plurality of generally cylindrical bores (not shown) formed therefrom. Each bore receives a preferably helical locking spring 92 for biasing a spherical locking ball 94. The locking balls 94 cooperate with the grooves 32 and locking notches 34 of the upper telescoping member 28.

A preferably helical first compression spring 96 is attached at a lower end to the weld washer 102 and at an upper end to a lower surface of the pedestal member 48 of the intermediate shaft guide 44. A preferably helical second compression spring 98 is attached at a lower end to an upper surface of the pedestal member 48 of the intermediate shaft guide 44 and at an upper end to a lower surface of the base member 62 of the upper shaft guide 58. The coils of the second spring 98 are preferably wound around the cylindrical member 46 of the intermediate shaft guide 44. A preferably helical third compression spring 100 is attached at a lower end to an upper surface of the base member 62 of the upper shaft guide 58 and at an upper end to a lower surface of the pedestal member 82 of the sleeve shaft guide 78. The coils of the third spring 100 are preferably wound around the tubular member 60 of the upper shaft guide 58. The springs 96, 98, and 100 bias the gear shifter 10 in the fully extended position, shown in FIG. 1.

The gear shift handle 42 has an axial bore formed therein for receiving a key lock 104. The key lock 104 includes a keyhole 106 that receives a key (not shown), preferably the vehicle ignition key, which enables the key lock 104 to rotate about an longitudinal axis 43 of the gear shifter 10 in a direction depicted by an arrow 105 when the key is inserted therein. A shaft 108 extending downwardly from the key lock 104 has a flange 110 formed on a lower end that attaches to the inner surface of the tubular member 80 of the sleeve shaft guide 78. Rotating the key in the key lock 104, therefore, rotates the shaft 108, the sleeve shaft guide 78, the upper shaft guide 58, and the intermediate shaft guide 44 with respect to the telescoping members 12, 20, and 28. The base telescoping member 12 is prevented from rotating by the shaft 116. The intermediate telescoping member 20 is preferably prevented from rotating by a pin (not shown) extending outwardly from an outer surface thereof that engages with a groove 85 on the interior surface 14 of the base telescoping member 12. Alternatively, a pin (not shown) extends from the interior surface 14 of the base telescoping member 12 and engages with a groove (not shown) in the outer surface of the intermediate telescoping member 20. Likewise, the upper telescoping member 28 is preferably prevented from rotating by a pin 86 extending outwardly from an outer surface thereof that engages with a groove 87 on the interior surface 22 of the intermediate telescoping member 20. Alternatively, a pin (not shown) extends from the interior surface 22 of the intermediate telescoping member 20 and engages with a groove (not shown) in the outer surface of the upper telescoping member 28. Likewise, the sleeve 36 is preferably prevented from rotating by a pin (not shown) extending outwardly from an outer surface thereof that engages with a groove (not shown) on the interior surface 30 of the upper telescoping member 28. Alternatively, a pin (not shown) extends from the interior surface 30 of the upper telescoping member 28 and engages with a groove (not shown) in the outer surface of the sleeve 36. Alternatively, the telescoping members 20 and 28 and the sleeve 36 utilize similar antirotation means, such as cooperating keys and keyways (not shown), for preventing the telescoping members 20 and 28 and the sleeve 36 from rotating when the key in the key lock 104 rotates the shaft 108, the sleeve shaft guide 78, the upper shaft guide 58, and the intermediate shaft guide 44.

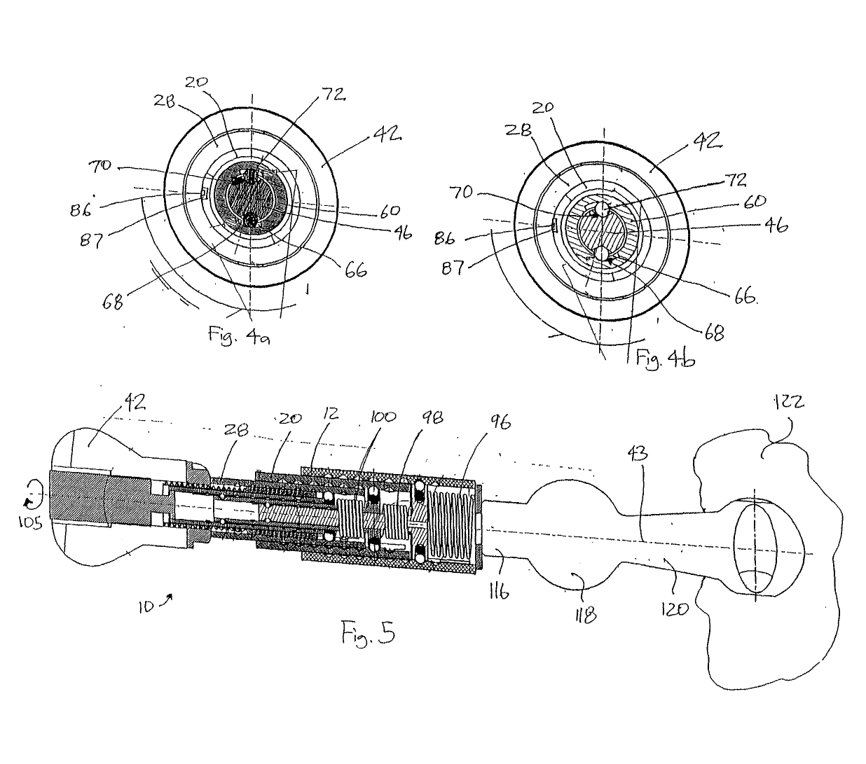

The spring tension in the key lock 104 biases gear shifter 10 in a locked position, best seen in FIGS. 3b and 4b, where the balls 56 and 72 are disposed in the corresponding locking notches 26 and 68. The locking notches 26 and 68 have a generally diamond-shaped profile, which, in combination with the spring tension of the spring 54 (in FIG. 3b), prevents axial movement of the telescoping members 20 and 28 in the locked position.

When the key is inserted into the key lock 104 and rotated in an unlocking direction depicted by an arrow 112, the locking balls 56 and 72 align with the grooves 16 and 66, best seen in FIGS. 3b and 4b, enabling movement of the telescoping members 20 and 28 by applying an upward or downward force to the telescoping members 20 and 28. A downward force on the telescoping members 20 and 28 compresses the springs 96, 98, and 100. An upward force on the telescoping members 20 and 28 decompresses the springs 96, 98, and 100. After the gear shifter 10 is at its desired length, the key lock 104 is rotated in a locking direction depicted by an arrow 114, returning to the closed, locked position so that the gear shifter 10 may be used in a normal manner. Each axial position of the grooves 16, 24, 32, and 66 (and the grooves not shown in the shaft guide 78), and the locking notches 18, 26, 34, 68 and 88 corresponds to a point where the gear shifter 10 may be locked in place. The grooves 16, 24, 32, and 66 (and the grooves not shown in the shaft guide 78), and the locking notches 18, 26, 34, 68 and 88 are axially spaced apart by the same distance so that when the gear shifter 10 is extended or retracted, each locking ball 56, 72, 76, 90 and 94 will be disposed in a corresponding locking notch 18, 26, 34, 68 and 88 when the gear shifter 10 is at a desired length. The effective length of the gear shifter 10 is thus advantageously adjustable from a fully extended position to a fully retracted position including numerous intermediate positions that correspond to the locking notches 18, 26 and 34 of the telescoping members 12, 20, and 28.

In the fully retracted position, best seen in FIG. 5, the springs 96, 98, and 100 are compressed and a greater amount of the length of the intermediate telescoping member 20 is disposed within the base telescoping member 12 as compared with FIG. 1. A greater amount of the length of the upper telescoping member 28 is disposed within the intermediate telescoping member 20 as compared with FIG. 1, and the handle 42 contacts an upper surface of the upper telescoping member 28,

The various components of the gear shifter 10 are preferably constructed of steel, aluminum, plastic, or similar material able to withstand the torque of normal gear shifting. The outer surfaces of the telescoping members 12, 20, and 28 are preferably smooth to facilitate easier telescoping motion between the members 12, 20, and 28. While the telescoping members 12, 20, and 28, and the sleeve 36 illustrated are tubular in shape, those skilled in the art will appreciate that the telescoping member 12, 20, and 28, and the sleeve 36 may be of any shape that allows the members 12, 20, and 28 and the sleeve 36 to telescope and be able to withstand the torque to which a gear shifter 10 is subjected. Although the gear shifter 10 is illustrated with a locking means including locking balls biased by springs cooperating with grooves and locking notches in the inner diameter of the telescoping shafts, the present invention contemplates utilizing various locking means while remaining within the scope of the invention.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A variable length gear shifter comprising:
at least two hollow elongated telescoping members movable relative to one another along a longitudinal axis, one of said telescoping members having an end adapted to be attached to a shaft extending from a transmission and another of said telescoping members extending to a free end for grasping by a human hand; and
a releasable locking means for locking said telescoping members telescoped together in a selected one of a plurality of predetermined locking positions, each said locking position determining a different distance between said end of said one telescoping member and said free end of said another telescoping member.

2. The variable length gear shifter according to claim 1 wherein said telescoping members are tubular shafts.

3. The variable length gear shifter according to claim 1 including a handle attached to said free end of said another telescoping member.

4. The variable length gear shifter according to claim 1 wherein said plurality of predetermined locking positions is defined by a plurality of notches formed in an interior surface of said one telescoping member.

5. The variable length gear shifter according to claim 4 wherein said releasable locking means includes at least one spring-loaded ball cooperating with said plurality of notches to prevent relative movement between said telescoping members.

6. The variable length gear shifter according to claim 5 including a groove formed in said interior surface of said one telescoping member and extending generally parallel to said longitudinal axis, said groove cooperating with said at least one spring-loaded ball for permitting said relative movement along said longitudinal axis.

7. The variable length gear shifter according to claim 6 wherein said releasable locking means includes means for rotating said telescoping members relative to one another to move said at least one spring-loaded ball between said notches and said groove.

8. The variable length gear shifter according to claim 7 including another groove formed on said interior surface of said one telescoping member and a pin extending outwardly from an exterior surface of said another telescoping member, said pin and said another groove cooperating to prevent relative rotation between said one telescoping member and said another telescoping member when said means for rotating moves said at least one spring-loaded ball between said notches and said groove.

9. A variable length gear shifter for attaching to a shaft to operate a transmission comprising:
at least two hollow elongated telescoping members movable relative to one another along a longitudinal axis, one of said telescoping members having an end adapted to be attached to a shaft extending from a transmission;
a sleeve telescopically received by another of said telescoping members and having a free end for grasping by a human hand, said sleeve being movable relative to said telescoping members along said longitudinal axis; and
a releasable locking means for locking said sleeve and said telescoping members telescoped together in a selected one of a plurality of predetermined locking positions, each said locking position determining a different distance between said free end of said sleeve and said end of said one telescoping member.

10. The variable length gear shifter according to claim 9 including a handle attached to said free end of said sleeve for grasping by a human hand.

11. The variable length gear shifter according to claim 10 wherein said handle has an axial bore formed therein and including a key lock received in said bore of said handle, said key lock being connected to said locking means for actuating said locking means between a selected one of said locking positions and an unlocked position permitting relative axial movement of said sleeve and said telescoping members.

12. The variable length gear shifter according to claim 9 wherein said locking means includes a plurality of notches formed in an interior surface of each of said telescoping members, each of said notches defining an associated one of said predetermined locking positions, and a pair of shaft guides selectively engaging said notches to prevent relative axial movement of said sleeve and said telescoping members.

13. The variable length gear shifter according to claim 12 wherein said locking means includes at least one longitudinally extending groove formed in said interior surfaces of said telescoping members, said shaft guides being movable from engaging said notches to engaging said grooves to permit relative axial movement of said sleeve and said telescoping members.

14. The variable length gear shifter according to claim 13 including another groove formed on said interior surfaces of said telescoping members and a pin extending outwardly from an exterior surface of each of said telescoping members except said one telescoping member, said pin and said another groove cooperating to prevent relative rotation between said telescoping members when said shaft guides move from engaging said notches to engaging said grooves.

15. The variable length gear shifter according to claim 9 wherein said key lock is operated by an automobile ignition key.

16. An automobile transmission and variable length gear shift assembly comprising:
a transmission having a shifting shaft extending therefrom;
at least two hollow elongated telescoping members each having a plurality of locking notches formed in an interior surface thereof, a base member of said telescoping members affixed to said shaft;
a sleeve received by an upper member of said telescoping members;
at least two shaft guides received inside said telescoping members, said shaft guides engaging said locking notches to prevent relative movement among said sleeve and said telescoping members and to selectively determine a different distance between said shifting shaft and said sleeve for each said locking notch; and
a key lock attached to said sleeve for disengaging said shaft guides from said notches to permit relative telescoping axial movement among said sleeve and said telescoping members.

17. The assembly according to claim 16 wherein said transmission is a manual transmission.

18. The assembly according to claim 16 wherein said transmission is an automatic transmission.

19. The assembly according to claim 16 wherein said key lock is operated by an ignition key.

20. The assembly according to claim 16 including another groove formed on said interior surfaces of said telescoping members and a pin extending outwardly from an exterior surface of each of said telescoping members except said base telescoping member, said pin and said another groove cooperating to prevent relative rotation between said telescoping members when said shaft guides disengage from said notches.
